(19) United States
(12) Patent Application Publication
(10) Pub. No.: US 2012/0214464 A1
(43) Pub. Date: Aug. 23, 2012

(54) METHODS AND SYSTEMS FOR IMPROVING ROAD SAFETY USING WIRELESS COMMUNICATION

(75) Inventors: Ariton E. XHAFA, Plano, TX (US); Min XU, Plano, TX (US)

(73) Assignee: TEXAS INSTRUMENTS INCORPORATED, Dallas, TX (US)

(21) Appl. No.: 13/399,595

(22) Filed: Feb. 17, 2012

Related U.S. Application Data
(60) Provisional application No. 61/444,232, filed on Feb. 18, 2011.

(51) Int. Cl. H04W 4/04; H04W 64/00

(52) U.S. Cl. 455/418

(57) ABSTRACT

A wireless communication device includes an antenna coupled to a wireless communications transceiver, a processor, and a vehicle safety application. When the vehicle safety application is executed, it causes the processor to cause the wireless communication device to join a basic service set through the antenna and wireless communications transceiver. The application also causes the processor to determine a location of the wireless communication device, receive location information indicative of a location of another wireless communication device in the basic service set, and generate an alert based on the determined location and the received location information.

### CROSS-REFERENCE TO RELATED APPLICATION

The present application claims priority to U.S. Provisional Patent Application No. 61/444,232, filed on Feb. 18, 2011 (Attorney Docket No. TI-70572PS); which is hereby incorporated herein by reference.

### BACKGROUND

An increase in the availability and types of wireless local area networks (WLAN) presents users of WLAN-equipped devices with communication options that were not previously practical. IEEE 802.11p is a WLAN standard that enables wireless access in vehicular environments. Similar to IEEE 802.11a/n/ac, 802.11p operates in the 5-gigahertz (GHz) frequency band. Electronic devices equipped with a transceiver suitable for 802.11p communication may exchange data between vehicles or between a vehicle and roadside infrastructure designed for 802.11p communication.

The ability to exchange data using 802.11p by itself does not provide any benefit or utility to a user. To provide useful content to the user based on data exchanged using 802.11p, associated hardware such as processors, displays, speakers and the like are required. Unfortunately, retrofitting 802.11p transceivers and associated hardware to automobiles currently on the road is costly and often times make- or model-specific. Additionally, automobile manufacturers are hesitant to invest in a wireless communication standard that has not previously been integrated into the automobiles they produce. Thus, benefits of vehicle-to-vehicle (V2V) or vehicle-to-roadside access point (AP) are not currently available to a majority of drivers and the time and cost required to provide such functionality in both used and new automobiles is prohibitive.

### SUMMARY

In accordance with some embodiments, a wireless communication device includes an antenna coupled to a wireless communications transceiver, a processor, and a vehicle safety application. When the vehicle safety application is executed by the processor, it causes the processor to cause the wireless communication device to join a basic service set through the antenna and wireless communications transceiver. The application also causes the processor to determine a location of the wireless communication device, receive location information indicative of a location of another wireless communication device in the basic service set, and generate an alert based on the determined location and the received location information.

In other embodiments, a method includes joining, by a wireless communication device, a basic service set; determining a location of the wireless communication device; receiving location information indicative of a location of another wireless communication device in the basic service set; and generating an alert based on the determined location and the received location information.

In still other embodiments, a machine-readable storage device contains machine-readable instructions. When the instructions are executed by a hardware processor of a wireless communication device, they cause the hardware processor to cause the wireless communication device to join a basic service set. The instructions also cause the hardware processor to determine a location of the wireless communication device, receive location information indicative of a location of another wireless communication device in the basic service set, and generate an alert based on the determined location and the received location information.

### BRIEF DESCRIPTION OF THE DRAWINGS

For a detailed description of exemplary embodiments of the invention, reference will now be made to the accompanying drawings in which:

FIGS. 1a-1c show exemplary wireless communication devices in accordance with various embodiments;

FIGS. 2a-2b show an exemplary traffic scenario in accordance with various embodiments; and

FIG. 3 shows a method flow chart in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

As used herein, the term “wireless communication device” refers to any device capable of wireless local area network (WLAN) communication.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Many wireless communication devices such as smart phones utilize transceivers that operate in the 2.4 GHz and/or 5 GHz bands for WLAN communications (e.g., internet browsing, e-mail, infotainment, and general data traffic) using the 802.11 standard. For example, 802.11b/g/n utilize the 2.4 GHz band while 802.11a/n/ac may utilize the 5 GHz band. As explained above, 802.11p also utilizes the 5 GHz band; thus, for at least those wireless communication devices that contain an 802.11a/n/ac transceiver, 802.11p functionality may be added with minimal changes to the hardware of the device. Additionally, the rate at which users upgrade their smart phones and similar products coupled with the low cost of adding hardware and software necessary for 802.11p communication may result in a rapid proliferation of 802.11p communication capabilities in wireless communication devices such as smart phones. In accordance with various embodiments, the 802.11p standard is utilized to provide safety information to the user of a wireless communication device while other 802.11 standards (i.e., b/g/a/n/ac) are utilized for infotainment purposes, for example as on current smart phones.

The simultaneous operation of different 802.11 standards for infotainment purposes and to provide safety information, particularly in the 5 GHz band, can cause detrimental mutual interference. For example, out-of-band transmissions using one WLAN standard may saturate a receiver attempting to receive a communication using another WLAN standard, causing signal corruption. Additionally, many wireless communication devices also support global positioning system (GPS) communications, FM radio communications, and/or Bluetooth (BT) communications, all of which may create further communication problems due to out-of-band emissions.

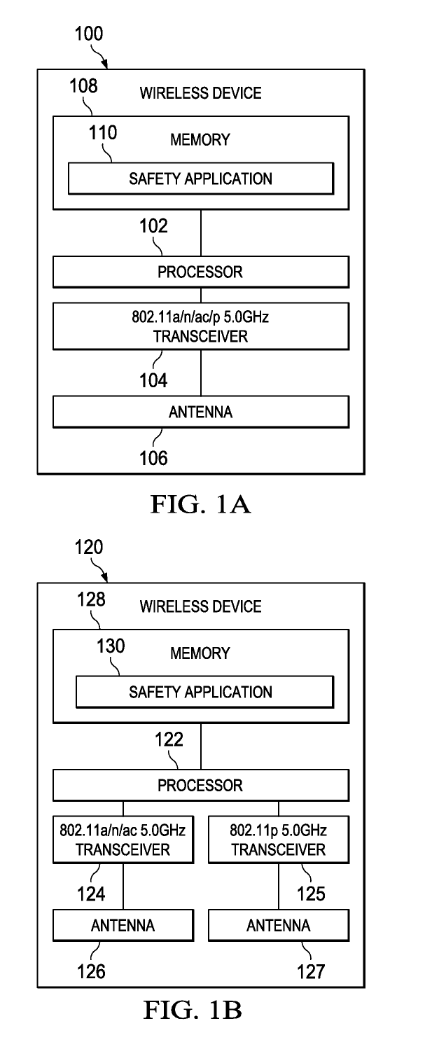

Turning now to FIGS. 1a-1c, various techniques for WLAN coexistence for wireless communication devices are explained. FIG. 1a shows a wireless communication device 100, such as a smart phone, having a processor 102 coupled to a single 802.11 transceiver 104, which operates in the 5 GHz band to transmit and receive data using the 802.11a/n/ac/p standards. The 802.11 transceiver 104 is coupled to an antenna 106 that physically transmits and receives data. Further, the processor 102 is coupled to a memory 108 that stores a safety application 110.

As shown, the wireless communication device 100 utilizes a single transceiver 104. However, in certain situations the user of the wireless communication device 100 may require use of the wireless communication device 100 for both infotainment purposes and for V2V communication, for example to utilize functionality provided by the safety application 110. In such a case, 802.11a/n/ac may be used for infotainment, while 802.11p is used for V2V or vehicle-to-roadside AP communication. Operation of the transceiver 104 may be time multiplexed to mitigate interference and enable coexistence between the 802.11a/n/ac and 802.11p standards. In a device implementing time multiplexing, each 802.11 standard may be allocated exclusively to the transceiver 104 for a time period. In some embodiments, communications using 802.11p may be given a higher priority than those using 802.11a/n/ac because of the importance of providing safety information to the user, for example via the safety application 110 that uses 802.11p communications.

FIG. 1b shows a wireless communication device 120, such as a smart phone, having a processor 122 coupled to a transceiver 124, which operates in the 5 GHz band to transmit and receive data using the 802.11a/n/ac standards. The processor 122 is also coupled to a transceiver 125, which also operates in the 5 GHz band, but transmits and receives data using the 802.11p standard. Each transceiver 124, 125 is coupled to an antenna 126, 127 that physically transmits and receives data. Further, the processor 122 is coupled to a memory 128 that stores a safety application 130.

The wireless communication device 120 may utilize both 802.11a/n and 802.11p standards at the same time, since each standard has a dedicated transceiver 124, 125. By using interference mitigation techniques, such as selecting channels that are spaced far apart from one another, the likelihood of signal corruption between transceivers 124, 125 is reduced. However, in some cases, out-of-band emissions may still cause signal corruption and require the use of additional coexistence techniques, such as restricting one transmitter 124 from transmitting data while the other transmitter 125 receives data, or vice versa.

FIG. 1c shows a wireless communication device 140, such as a smart phone, having a processor 142 coupled to a transceiver 144, which operates in the 2.4 GHz band to transmit and receive data using the 802.11g/n standards. The processor 142 is also coupled to a transceiver 145, which operates in the 5 GHz band to transmit and receive data using the 802.11p standard. Each transceiver 144, 145 is coupled to an antenna 146, 147 that physically transmits and receives data. Further, the processor 142 is coupled to a memory 148 that stores a safety application 150. Unlike FIGS. 1a and 1b, the transceivers 144, 145 operate in different frequency bands, which greatly reduces the likelihood of interference between transceivers causing signal corruption. However, second harmonics from the 2.4 GHz transceiver 144 may be tuned such that they do not interfere with the 5 GHz transceiver 145.

The varying transceiver arrangements shown in FIGS. 1a-1c are exemplary and show various coexistence techniques that may be used to enable communication using both 802.11b/g/a/n/ac for infotainment purposes and 802.11p for V2V or vehicle-to-roadside AP communications. One skilled in the art appreciates that additional transceivers may be included in the wireless communication devices (e.g., for GPS, BT, or FM communications). Further, although 802.11p is specifically designed for wireless access in vehicular environments, other wireless standards or protocols may be similarly used in accordance with the various embodiments disclosed herein. Thus, in some embodiments, the transceivers 104, 124, 125, 144, 145 may comprise a wireless communications transceiver that operates using a wireless standard or protocol other than 802.11. Additionally, certain wireless communication devices such as smart phones may comprise additional elements not shown in FIGS. 1a-1c, such as displays, microphones, speakers, I/O ports and devices, and the like. As will be explained in further detail below, the safety application 110, 130, 150, when executed by a processor, leverages 802.11p communications to provide enhanced safety information to the user of the wireless communication device 100, 120, 140.

In accordance with various embodiments, a wireless communication device is equipped with hardware and associated software to enable the device to communicate using the 802.11p standard, which is used generally for wireless access in vehicular environments as explained above. Wireless access using the 802.11p standard may be via an ad hoc network between vehicles, through a roadside AP, or through a combination of the two. However, no standard or protocol exists to utilize data transmitted using the 802.11p standard and, as such, merely equipping a wireless communication device to use the 802.11p standard does not achieve a useful result. Thus, in accordance with various embodiments, information about other vehicles or traffic signals near or around the user may be exchanged over an 802.11p network and used by the safety application 110 to provide safety information to the user, for example in the form of an alert or notification (e.g., audible alert through a speaker or visual notification on a display). The information exchanged over the 802.11p network may include, for example, location or position of vehicles, velocity and direction of vehicles (which may be derived from change in location or position or received directly from the vehicle itself), or status of a traffic signal, such as a traffic light.

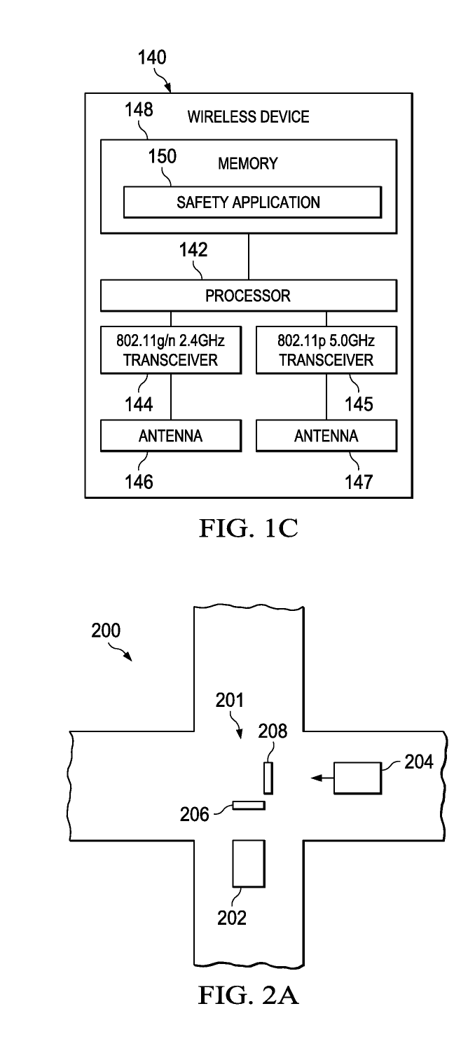

Referring now to FIGS. 2a and 2b, the safety application is explained in the context of a traffic scenario. FIG. 2a shows a first snapshot 200 of a traffic scenario, in which vehicle 202 is stopped at a red traffic light 206 and vehicle 204 is traveling toward the intersection 201 and a traffic signal 208. The traffic signal 208 is yellow and about to turn red. FIG. 2b shows a second snapshot 210 of the traffic scenario shown in FIG. 2a, but later in time. The traffic light 206 has turned green and the traffic light 208 has turned red, although the vehicle 204 attempts to “catch” the previously-yellow traffic light and is shown running the intersection 201. The driver of vehicle 202 is unaware of the fact that vehicle 204 is running the intersection and properly proceeds into the intersection 201 as a result of the traffic light 206 being green. A collision between the two vehicles, while not guaranteed, is an unfortunate and common occurrence in such a scenario. Thus, in accordance with various embodiments, communications between 802.11p vehicles, traffic signals, and the like are leveraged to provide an alert or notification to the driver of vehicle 202 that proceeding into the intersection 201 is not advisable, despite the green traffic light 206. As a result, the likelihood of a collision is greatly reduced.

Other similar scenarios may be avoided and, in some cases, the safety application may utilize additional information to provide an alert or notification. For example, a driver's smart phone located in a vehicle properly traveling through an intersection may receive location information from a wireless device of a jaywalking pedestrian, causing an alert to be generated notifying the driver of the potential risk of a collision with the pedestrian. Many other scenarios are envisioned where location, velocity, and direction of vehicles may be used by safety applications installed on wireless communication devices in the vehicles and communicating via an 802.11p network to generate an alert or notification. In some cases, the alert or notification may comprise a traffic alert, for example informing a user that a traffic jam or condition exists on the road ahead, enabling the user to chose an alternate route. Further, the safety application itself may determine an alternate route based on location, velocity, and direction of travel information received from other vehicles via the 802.11p network.

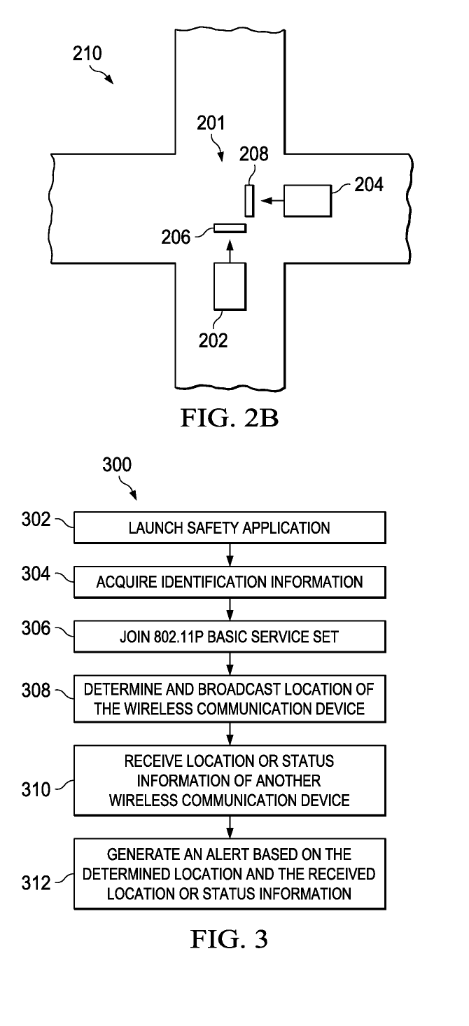

Referring now to FIG. 3, a method 300 is shown in accordance with various embodiments. The method 300 begins in block 302 when the safety application 110 is launched. This may be done, for example, by a user selecting an icon on their smart phone that corresponds to the safety application 110. When the safety application 110 is launched, the 802.11p and GPS transceivers of the smart phone are turned on if they are not already on. The method 300 continues in block 304 when identification information is acquired by the safety application 110. The identification information serves to associate the wireless communication device with a particular person (e.g., the user) or vehicle (e.g., the vehicle that a user is driving or traveling in). In some cases, vehicle identification information (e.g. a vehicle identification number (VIN)) may be acquired via Bluetooth if the vehicle is so equipped, may be manually entered by the user, or may be retrieved from a cache memory if the identification information has been used by the device at a prior time.

The method 300 continues in block 306 when the safety application 110 causes the wireless communication device to join an 802.11p basic service set (BSS). A BSS is the basic building block of an 802.11 WLAN and may comprise an ad hoc network of 802.11p-equipped wireless communication devices or an AP-based network, for example using an intersection-located 802.11p AP or a roadside-located 802.11p AP. An 802.11p BSS differs from other 802.11 BSSs because it enables stations to transmit and receive data without the need to belong to any BSS a priori. A station may start an 802.11p BSS by transmitting a beacon using regular beacon frames that are not required to be repeated periodically. An 802.11p receiver may decide to join the 802.11p BSS by listening to the 80211p beacon and any configuration information transmitted with the beacon. The safety application 110 may cause the wireless communication device to create an 802.11p BSS, which may then be joined by other 802.11p devices. Alternately, if no other 802.11p devices are in the area, then the safety application 110 may cause the 802.11p transceiver to turn off, for example to save a battery of the wireless communication device when 802.11p communications are not possible.

The method 300 then continues in block 308 when a location of the wireless communication device is determined and broadcasted to other 802.11p devices in the BSS. The location of a wireless communication device such as a smart phone may be determined in many known ways, such as through the use of a GPS location device, cellular triangulation, or other known location techniques. The location of the wireless communication device can be used by the safety application 110 to determine its relative position to other 802.11p devices in the BSS. Similarly, the other 802.11p devices in the BSS may comprise similar safety applications that use the location of the wireless communication device to generate their own alerts.

The method 300 continues in block 310 when the 802.11p transceiver receives location or status information from another 802.11p device in the BSS; this information is provided to the safety application 110. The location or status information is indicative of the location or status of the other 802.11p device. One skilled in the art appreciates that change in location over a given time is determinative of velocity and direction as well, and thus the safety application 110 may determine the velocity and direction of travel of the other 802.11p device. Alternately, the velocity and direction information may be directly transmitted via the 802.11p network, for example from a vehicle's on-board computer. In some for some 802.11p devices, such as 802.11p-equipped traffic lights, status (e.g., red, yellow, green, time until change) is more important than location or velocity, and thus status information is received in place of or in addition to location information.

The method 300 concludes in block 312 when the safety application generates an alert based on the determined location of the wireless communication device and the received information relating to the location and/or status of other 802.11p devices. For example, if, as explained above, the safety application determines that a collision is possible between its user (or associated vehicle) and an 802.11p-equipped vehicle (or vehicle associated with an 802.11p-equipped wireless communication device), an alert or notification may be generated to warn the user. Furthermore, as explained above, the safety application 110 may alert the user to other conditions such as traffic signals, traffic conditions, likely vehicular or pedestrian collisions, and the like.

The method 300 may be performed, for example, by the processor of a wireless communication device executing the safety application. Additionally, the wireless communication device may couple to or include a machine-readable storage device, such as a compact disc, floppy disc, flash-based storage, or other non-transitory storage device. The machine-readable storage device includes machine-readable instructions that, when executed by the processor, cause the processor to carry out some or all of the various functionality and/or methods (e.g., method 300 of FIG. 3) described herein.

As explained above, integrating 802.11p functionality into wireless communication devices such as smart phones is simpler and has a reduced time-to-market when compared to integrating 802.11p functionality directly into automobiles. Additionally, because there is no (or very little) dependence on the electronics of the vehicle itself, the above-described embodiments may be utilized in conjunction with vehicles of varying ages, makes and models. Thus, enhanced safety information may be provided to drivers and pedestrians in a rapidly scalable manner without having to wait for vehicle manufacturers to agree upon and integrate a similar technology.

The above discussion is meant to be illustrative of the principles and various embodiments of the present invention. Numerous variations and modifications will become apparent to those skilled in the art once the above disclosure is fully appreciated. For example, although mainly discussed with respect to 802.11p-equipped wireless communication devices in vehicles, information may be gathered from 802.11p-equipped devices associated with traffic signals (e.g., to warn a driver of an impending red light, an exit to be taken for navigation purposes, or other traffic signal) or pedestrians. As another example, in some cases the safety application also functions as a coexistence controller if coexistence schemes need to be implemented to enable 802.11p communication in addition to other 802.11 communications; however, in other cases, a standalone coexistence controller may be utilized to provide similar functionality. It is intended that the following claims be interpreted to embrace all such variations and modifications.

What is claimed is:

1. A wireless communication device, comprising:
an antenna coupled to a wireless communications transceiver;
a processor; and
a vehicle safety application that, when executed, causes the processor to:
cause the wireless communication device to join a basic service set through the antenna and wireless communications transceiver;
determine a location of the wireless communication device;
receive location information indicative of a location of another wireless communication device in the basic service set; and
generate an alert based on the determined location and the received location information.

2. The system of claim 1 further comprising a GPS transceiver, wherein the vehicle safety application, when executed, further causes the processor to turn on the wireless communications transceiver and the GPS transceiver.

3. The system of claim 1 wherein the vehicle safety application, when executed, further causes the processor to acquire identification information of a person or vehicle associated with the wireless communication device.

4. The system of claim 1 wherein the vehicle safety application, when executed, further causes the processor to broadcast the location of the wireless communication device to another wireless communication device in the basic service set.

5. The system of claim 1 wherein the vehicle safety application, when executed, further causes the processor to create an basic service set if no basic service set exists in the proximity of the wireless communication device.

6. The system of claim 1 wherein the alert comprises a visual alert or an audio alert.

7. The system of claim 1 wherein the alert indicates a traffic condition, a likely collision condition, or a traffic signal status.

8. The system of claim 1 wherein the wireless communications transceiver comprises an 802.11p transceiver and the basic service set comprises an 802.11p basic service set.

9. A method, comprising:
joining, by a wireless communication device, a basic service set;
determining a location of the wireless communication device;
receiving location information indicative of a location of another wireless communication device in the basic service set; and
generating an alert based on the determined location and the received location information.

10. The method of claim 9 further comprising turning on a wireless communications transceiver of the wireless communication device.

11. The method of claim 9 further comprising acquiring identification information of a person or vehicle associated with the wireless communication device.

12. The method of claim 9 further comprising broadcasting the location of the wireless communication device to another wireless communication device in the basic service set.

13. The method of claim 9 further comprising creating a basic service set if no basic service set exists in the proximity of the wireless communication device.

14. The method of claim 9 wherein the alert indicates a traffic condition, a likely collision condition, or a traffic signal status.

15. The method of claim 9 wherein the basic service set comprises an 802.11p basic service set.

16. A machine-readable storage device containing machine-readable instructions that, when executed by a hardware processor of a wireless communication device, cause the hardware processor to:
cause the wireless communication device to join a basic service set;
determine a location of the wireless communication device;
receive location information indicative of a location of another wireless communication device in the basic service set; and
generate an alert based on the determined location and the received location information.

17. The machine-readable storage device of claim 16 wherein the instructions, when executed, further cause the processor to turn on a wireless communications transceiver and a GPS transceiver.

18. The machine-readable storage device of claim 16 wherein the instructions, when executed, further cause the processor to acquire identification information of a person or vehicle associated with the wireless communication device.

19. The machine-readable storage device of claim 16 wherein the instructions, when executed, further cause the processor to broadcast the location of the wireless communication device to another wireless communication device in the basic service set.

20. The machine-readable storage device of claim 16 wherein the instructions, when executed, further cause the processor to create a basic service set if no basic service set exists in the proximity of the wireless communication device.
